(19) United States
(12) Patent Application Publication
(10) Pub. No.: US 2008/0062631 A1
(43) Pub. Date: Mar. 13, 2008

(54) MULTI-FUNCTION DESKTOP ASSEMBLY

(76) Inventor: Dilip Bhavnani, Beverly Hills, CA (US)

Correspondence Address: THE SONI LAW FIRM, 55 S. LAKE AVE SUITE 720, PASADENA, CA, 91101, US

(21) Appl. No.: 11/470,993

(22) Filed: Sep. 7, 2006

(51) Int. Cl. G06F 1/16

(52) U.S. Cl. 361/683

(57) ABSTRACT

The present invention directs to a multi-function desktop assembly comprising a multi-purpose board, an assembly frame, and preferably an assembly base. The multi-purpose board is rotatably connected within the cavity in the assembly frame such that each side of the board may be selectively, and conveniently accessed from the front side of the frame by rotating the board. The assembly frame can assume between a substantially upright position and a flat position via preferably a hinged connection to the assembly base. On each side of the multi-purpose board is formed, in one embodiment, a magnetic dry erase surface that can attract magnets and a graphic displaying surface, respectively. In another, a LCD-mirror that acts as a LCD when powered and a mirror when unpowered and a graphic displaying surface, respectively. In still another embodiment, a LCD-mirror and a magnetic dry erase surface, respectively.

The present invention relates to field of a multi-function office desktop assembly, having a multi-purpose board that can be selectively used as a dry erase board, a photo/picture displayer, a magnetic memo-retaining board, a LCD, or a mirror, and common digital desktop electronics such as a digital alarm clock, timer, and thermometer.

### CROSS-REFERENCE TO RELATED APPLICATION

(Not Applicable)

### STATEMENT RE: FEDERALLY SPONSORED RESEARCH/DEVELOPMENT

(Not Applicable)

### BACKGROUND OF THE INVENTION

One of the common desktop utilities or accessories is a dry erase board, known also as a whiteboard. It is widely used in business offices, schools, and other places for quick creation, and temporary retention of, some memo writing or illustration. It is also quite useful as a presentation tool to a third party. Typically, such dry erase boards have a smooth and white polymeric surface coated on a substrate on which writings, marks, or drawings may be applied using colored dry-erase pens containing non-permanent ink. For renewed, repeated use of the polymeric surface, those writings, marks, or drawings are easily erased without leaving visible traces by wiping the surface lightly with dry fabrics, paper, or even human hands. The composing material of the polymeric coating is well known in the art.

Also widely used is a magnetic memo-retaining board, against which memo notes, advertising materials, or other pieces of paper can be retained via magnets. One prior art reference, U.S. Patent Application Publication No. 2005/0186439A1, teaches combining those two functions, implemented on a single board surface such that it is dry erasable as well as magnetically susceptible so as to have magnets attracted and adhered to it.

Other commonly used desktop accessories are desktop electronics such as a digital alarm clock, a count down alarm timer, and a thermometer, which are usually displayed on a LCD screen. A desktop mirror is also one of such accessories. Two prior art references, U.S. Patent Application Publication No. 2002/0167511A1 and U.S. Patent Application Publication No. 2006/0033867A1, are teaching the combination of a LCD screen and a mirror in which the so-called ‘LCD mirror’ performs as a LCD when powered, and as a mirror when unpowered.

While such combination obviously helps save desktop spaces and would contribute to enhancing work efficiencies, such purposes would be more served if aforementioned desktop utilities can be further combined with another common desktop accessory, such a photo/picture frame, to form an efficiently integrated and conveniently accessible desktop assembly.

Therefore, it would be desirable to provide a multi-purpose board that functions as, on one side, a dry erasable board that can act as a magnetic memo-retaining board as well, and on the other side, a photo frame. It would be also desirable to provide a multi-purpose board that functions as, on one side, a LCD mirror displaying digital signals, and on the other side, a photo frame. It would be yet desirable to provide a multi-purpose board that functions as, on one side, the LCD mirror, and on the other side, the dry erasable magnetic board referred to above.

It would highly be desirable to provide a desktop assembly integrating such a multi-purpose board, that is so structured that different functions formed on two opposite sides of the board can be selectively and conveniently accessible by a user. Moreover, it would be further desirable if such desktop assembly provides, with all the functions aforementioned, a neat and compact appearance as well, and even some space to place advertising materials for advertisement or promotion.

### SUMMARY OF THE INVENTION

The present invention provides a multi-function desktop assembly having a multi-purpose board retaining some of commonly used desktop utilities on both sides thereof, which is structured such that a user can easily and conveniently access either side of the board and thereby selectively use one of the utilities implemented on the board. The present invention further provides integration of the widely used digital desktop electronics such as a digital alarm clock, a countdown alarm timer, or a thermometer, which are displayed either through a LCD screen located in the assembly frame or through the LCD-mirror of the multi-purpose board.

The multi-function assembly made in accordance with the present invention is largely comprised of a multiple-purpose board, a planar assembly frame having a cavity to fit the board in, and an assembly base supporting the assembly frame in a substantially upright position. The assembly frame and the base are connected to each other such that the assembly frame can be either folded or rotated or otherwise collapsed with respect to the base so as to lie substantially parallel to the base. The multi-purpose board is configured and connected to the assembly frame such that both sides of the board may be selectively and conveniently accessible by a user via a mechanism that can selectively align each side of the board, as needed, coplanar with the front side of the assembly frame. More specifically, two side edges of the multi-purpose board may be pivotally connected, at their centers, to the edges of the cavity such that the board may freely rotate within the cavity to selectively align its both sides to be coplanar with the front side of the assembly frame.

There are several embodiments of the multi-purpose board contemplated in the present invention. The multi-purpose board comprises basically a rigid substrate, upon each side of which a different desktop functionality is implemented. In the first preferred embodiment, on one side of the substrate, a dry erase layer is superimposed to create a glossy dry erasable surface, and on the other side, which acts as a photo/picture frame, some means are formed for interchangeably retaining and selectively displaying thereon a plurality of photos or pictures either in imprinted form on sheets of paper, or in digital form. The glossy dry erase surface may further include, underneath, a magnetic layer that attracts magnets to the dry erase surface against which memos or pieces of paper can be detachably retained via the magnets. In this embodiment, the multi-function assembly may further comprise digital signal generators, such as a digital alarm clock, a countdown alarm timer, or a thermometer, preferably encased in the assembly frame.

In the second preferred embodiment, the multi-purpose board has, on one side, a LCD-mirror that can act as a LCD when powered and a mirror when unpowered, and on the other side, the photo/picture frame described in the first embodiment. In the third preferred embodiment, the multi-purpose board has, on one side, the aforementioned magnetic dry erasable surface, and the LCD-mirror on the other side.

Some of the advantages of the present invention, obtained by structurally and functionally integrating multiple office desktop utilities, are saving of desktop spaces, effectiveness and convenience in accessing multiple desktop functions, and the consequential enhancement in work efficiency. Other advantages for such integration are provision of a neat and compact appearance, and the resultant enhancement of aesthetics of working environment.

Yet another advantage of the present invention is to provide an effective method for advertising and promotion. Since the present invention would be accessed and used, supposedly, more frequently by a user owing to its integrated multiple functionality, it can be an effective vehicle for advertising purpose, whereby advertising or graphic materials can be permanently imprinted on any outer surface of the desktop assembly, including that of the multi-purpose board, assembly frame, and the assembly base.

### BRIEF DESCRIPTION OF THE DRAWINGS

FIG. 1 is a perspective view of the multi-function desktop assembly made according to the present invention, with the multi-purpose board displaying a photo-frame side.

FIG. 2 is a perspective view of the multi-function desktop assembly with the multi-purpose board being rotated in an exemplary manner according to the present invention while displaying a dry erase surface retaining thereon a memo via magnets.

FIG. 3 is a rear elevational view of the multi-function desktop assembly made according to the present invention, with the multi-purpose board displaying a dry erase surface.

FIG. 4 is a top plan view of the assembly base made according to the present invention in the first and third preferred embodiments.

FIG. 5 is a side elevational view of the multi-function desktop assembly made according to the present invention, with the assembly frame in a substantially upright position, being slightly tilted back from an upright position.

FIG. 6 is a side elevational view of the multi-function desktop assembly made according to the present invention, with the assembly frame in the substantially upright position obtained by flipping the assembly base in the FIG. 5 upside down.

FIG. 7 is a side elevational view of the multi-function desktop assembly made according to the present invention, with the assembly frame in a substantially flat position.

FIG. 8 is a front elevational view of the multi-function desktop assembly made according to the present invention, with the multi-purpose board displaying a LCD-mirror side.

FIG. 9 is a bottom plan view of the multi-function desktop assembly made according to the present invention.

### DETAILED DESCRIPTION OF THE INVENTION

The present invention generally relates to a multi-function office desktop assembly, having a multi-purpose board that can be selectively used as a dry erase board, a picture frame, a magnetic memo-retaining board, a LCD, or even a mirror, and some widely used digital desktop electronics such as a digital alarm clock, a countdown alarm timer, and a thermometer.

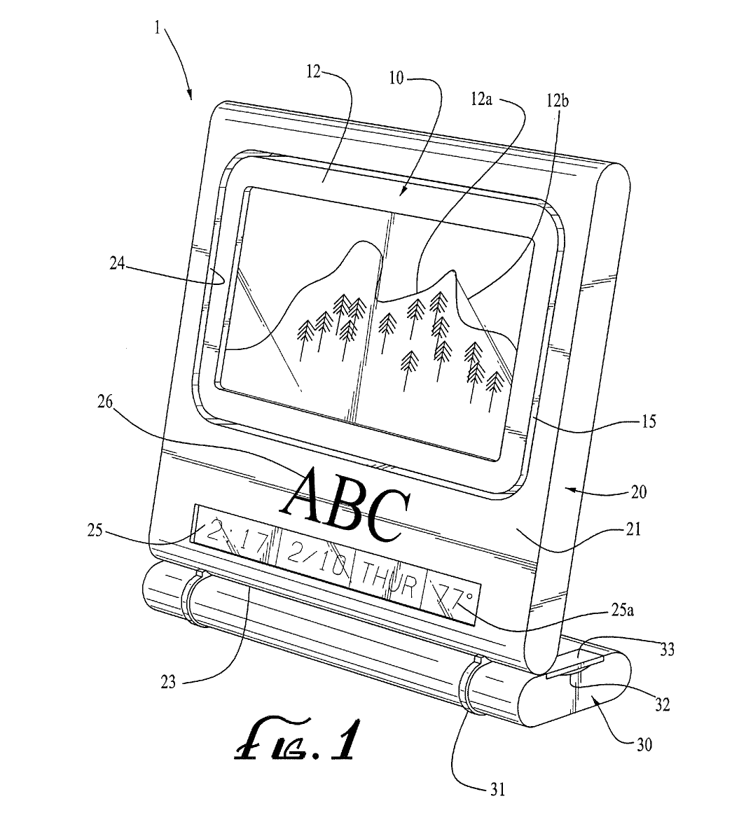

Several preferred embodiments of the present invention will now be described with reference to FIGS. 1-9, wherein like components are designated by like reference numerals throughout the figures. Although the present invention is generally described in terms of the preferred embodiments, it should be understood that it is shown and described, only by way of illustration of the best mode contemplated in carrying out the invention, but not intended to limit in any way the spirit and scope of the invention to the particular embodiments described.

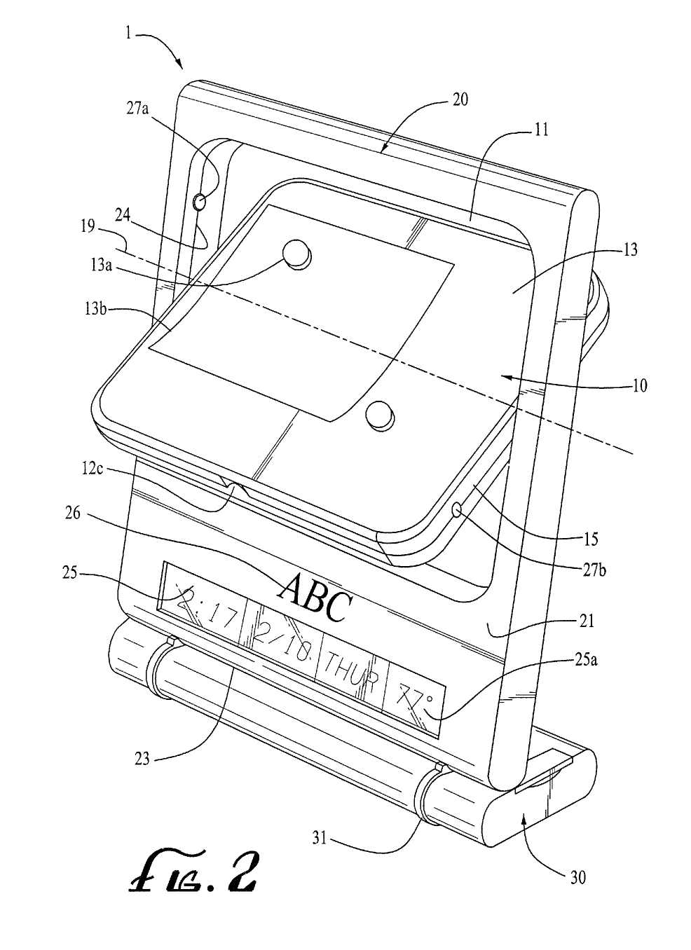

Now referring to the figures, FIGS. 1 and 2 show the general structure of the multi-function desktop assembly 1 in the preferred embodiment of the present invention, which comprises largely three parts, a multi-purpose board 10, an assembly frame 20, and preferably, an assembly base 30. The assembly frame 20 basically plays the role of an organizer that houses the multi-purpose board having diverse office desktop functions and also some common digital electronics such as a digital alarm clock, a countdown alarm timer, or a thermometer.

The assembly frame 20 defines thereon a board cavity 11 that is preferably symmetrically shaped and sized to fit therein the multi-purpose board 10. The cavity 11 is extended from the front frame side 21 to the rear frame side 22 of the assembly frame 20. In the preferred embodiments shown in FIGS. 1-8, the cavity 11 has a closed peripheral edge so that it may lie completely within and surrounded by the assembly frame 20. In another embodiment, a portion of the peripheral edge of the cavity may be open, being not bounded by any part of the assembly frame. For example in this embodiment, the upper frame edge above the cavity 11 in FIG. 1 may be absent to form a U-shaped cavity.

In the present invention, the multi-purpose board 10 is fitted in, and connected to the cavity in such a way that each of two sides of the board 10 can be selectively and easily aligned by a user to become coplanar with the front frame side 21. This feature will enable a user to selectively and conveniently access to both sides of the board, as needed, from the front frame side 21 without having to turn over the entire assembly frame 20. There could be several ways to achieve this purpose. In the preferred embodiment as shown in FIG. 2, the two side edges 15 of the board 10 may be pivotally connected, at their centers, to the two frame side edges 24 adjacent to the cavity 11, thereby defining a rotational axis 19 that would be, in this case, the horizontal symmetric axis of the board 10. In anther embodiment not shown in the drawings, the two upper and lower edges of the board 10 may be similarly connected to two upper and lower frame edges so that the board 10 may rotate about a vertical, instead of horizontal, symmetric axis of the board 10.

The multi-purpose board 10 is sized slightly smaller than the cavity to define a thin space between the edges of the frame 20 and the board 10 so that the board 10 may freely rotate within the cavity 11 as depicted in FIG. 2, while alternatively exposing each side of it to the front frame side 21. Also, there may be a detent 27a and a matching recess 27b formed respectively on the frame edge 24 and the board edge 15 as seen in FIGS. 2 and 3 so as to have the board 10 locked securably within the cavity 11 during the use of one of its side, while the board 10 can be still rotatable, easily, by pushing it about its rim with the user's finger.

The rotational connection described above is not the only way to selectively expose each side of the multi-purpose board to the front frame side. Other ways apparent to those skilled in the art are also contemplated by the present invention. For example, in another embodiment, the cavity may be open at one peripheral edge as previously described and define grooves along its two parallel edges. Then, a user may easily retract the board from the cavity via the grooves accessing from the open side of the cavity, flip it for use of the other side of the board, and similarly slide it back into the cavity.

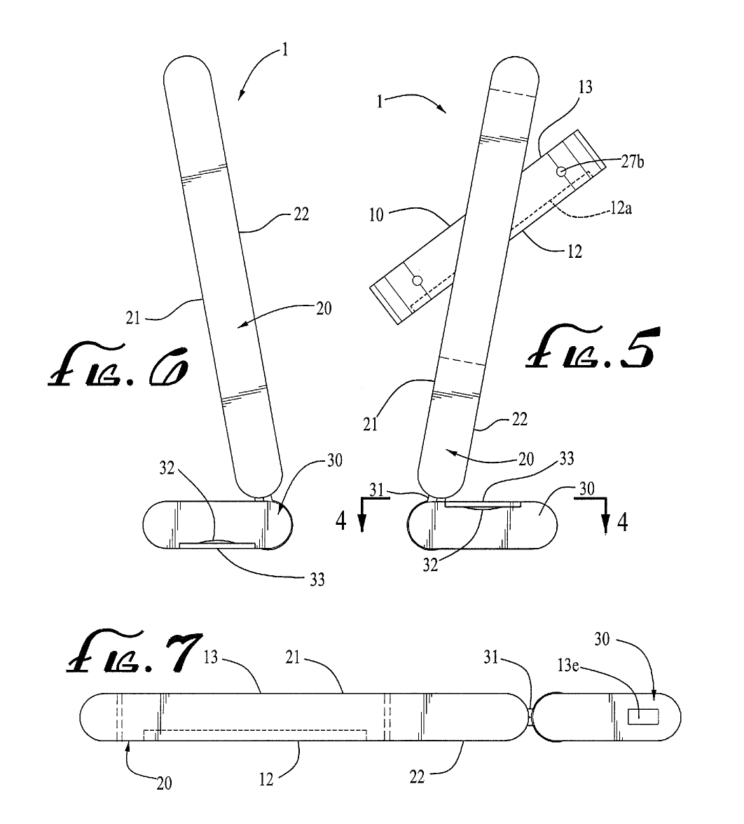

In most of the contemplated uses of the desktop assembly 1, it is desirable that the assembly frame 20 is in an upright, or substantially upright position as depicted in FIGS. 1-6 and 8 so that a user may easily view or manipulate the multi-purpose board 10 from the front frame side 21. For this purpose, in the preferred embodiment, the desktop assembly 1 further comprises an assembly base 30 hingedly connected to the assembly frame 20 at its bottom edge 23 as shown in FIGS. 1-8. FIG. 9 shows the bottom surface of the assembly base 30. Through the hinged connection, the assembly frame 20 may fold or hingedly rotate about the assembly base 30 to assume between a substantially upright position as shown in FIGS. 1-6 and 8, and a substantially flat position as shown in FIG. 7. In another embodiment, however, the assembly base 30 itself may flip about the hinged connection while the assembly frame 20 remains in the substantially upright position. As FIG. 6 shows, in this embodiment one may access two opposite sides of the assembly frame 20, or equivalently, opposite sides of the multi-purpose board 10 simply by flipping the assembly base 30 in FIG. 5 upside down instead of rotating the board 10 within the cavity 11. The hinged connection between the frame 20 and the board 10 may be effectuated by the commonly used ring-shaped joint member 31 depicted in the preferred embodiment in FIGS. 1-9, or by any other equivalent means recognized by those skilled in the art.

The substantially upright position of the assembly frame 20 may be obtained by other means than using the aforementioned assembly base 30. In another embodiment of the present invention, for example, the assembly frame 20 may stand substantially upright by one or more slanted linear supporting members that extend from the rear frame side to a horizontal surface, similar to those commonly used in a stand-alone desktop photo frame. Further, those supporting members could be made collapsible, if needed, to allow the assembly frame 20 to assume a substantially flat position as well. Other means for accomplishing the same purpose may be well known to those skilled in the art, and are also within the contemplated scope of the present invention.

The substrate of the multi-purpose board 10, the assembly frame 20, and the base 30 are generally flat and can be manufactured from any proper material, including but not limited to, wood, metal, plastics, cardboard, polymeric compositions, fiberglass, hardboard, or any other rigid or semi rigid material that can accept coatings on its outer surface. Their shape is not restricted to a rectangle or a square shown in FIGS. 1-8 for the preferred embodiment, but can be other geometrical, preferably symmetrical, shapes such as a circle or an ellipse without departing from the spirit of the invention.

There are three preferred embodiments of the multi-purpose board 10 contemplated by the present invention. Basically, the multi-purpose board 10 comprises a rigid substrate, upon each side of which a different desktop functionality is implemented. In the first preferred embodiment, the multi-purpose board 10 has a photo frame 12 formed on one side, and a dry erase/magnetic surface 13 formed on the other side. The photo frame side 12 of the multi-purpose board 10 has means formed thereon for interchangeably retaining and selectively displaying at least one photo, picture, or any other graphics, either in the format of physical imprints on pieces of paper 12a as shown in FIG. 1, or in a digital format.

If the photos or pictures are imprinted on a sheet of paper or any other substantially planar material, the aforementioned means may comprise, in the preferred embodiment as shown in FIG. 1, a compartment for retaining a photo therein defined within the board 10, part of which is exposed to the photo-frame side 12 to define a recess thereon through which the photo is displayed. The photo may be inserted into or taken out of the compartment for interchange through a slot 12c defined at an edge of the board 10 as shown in FIG. 2. In another embodiment, the photo may be replaceably fitted into the recess via grooves defined along the edge of the recess rather than via the slot 12c in FIG. 2. In either embodiment, the assembly frame 20 could further comprise a transparent cover 12b detachably disposed on top of the photo 12a for its protection. In still another embodiment, the photo can be removably retained directly on the photo-frame side 12 by a variety of attachment means formed on the photo-frame side 12 which are commonly used in a photo frame, such as pins, clips, clamps, adhesives, scotch tapes, or double-sided tapes.

If the photos or pictures are in digital format, the board 10 may encase an electric circuitry therein for reading and selectively displaying the digital photos or pictures. To display such digital images, a display screen, or a LCD, may be formed on the photo-frame side 12. The digital photos or pictures may be stored in rewrittable memory device, such as the widely used flash memory, which may be removably fitted into a slot defined at an edge of the multi-purpose board 10. Such electric circuitry, display screen, and memory device are well known in the art and thus, not described herein further. To supply power to the electric circuit and the display screen, a power unit may be further encased in either the board 10, the assembly frame 20, or the assembly base 30. For instance, in one embodiment, a battery compartment may be formed on a side edge 15 of the board 10, but in another, it may be formed either on the assembly frame 20 or the assembly base 30 and the power is transmitted to the electric circuit within the board 10 through an electric contact formed within the hinged connection by which the board 10 is connected to the cavity 11. Furthermore, the board 10 may comprise an input unit such as control buttons disposed on the board 10, preferably at one side of the display screen, for turning on or off power and selecting among the plurality of digital graphics.

FIG. 2 shows the dry erase surface side 13 of the multi-purpose board 10. On that side of the substrate, a dry erase layer is applied so as to create a glossy, typically white, dry erasable surface 13. The dry-erase surface 13 is formed by either coating or printing adequate material on the substrate plate. Writings, markings, or graphics may be applied on the dry erase surface 13, using a dry-erase pen 13c that contains non-permanent ink, which are then easily erasable by gently wiping the surface 13 with fabrics, other tender material, or even human hands. The typical composing material of such dry erase layer, the process of applying dry erase coating or printing to the substrate, the typical coating or painting thickness, and the techniques for treating the dry erase surface 13 to render it glossy and white are all practiced and well known in the art, and thus, not presented here in detail.

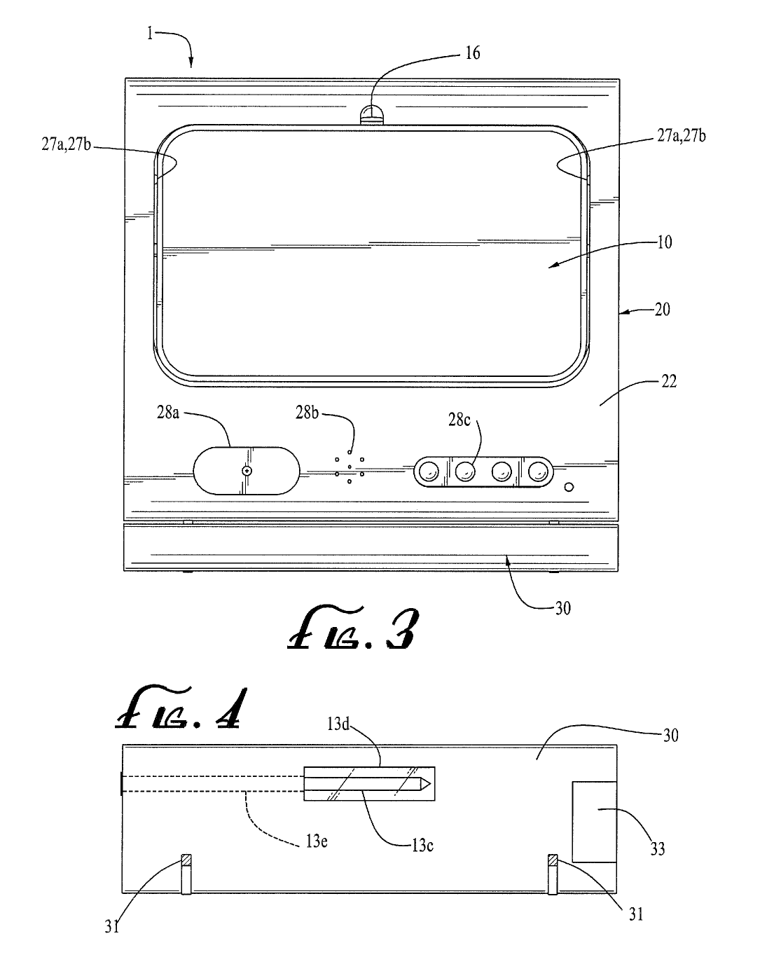

Further in this embodiment, the assembly 1 may comprise a member formed thereon to retain therein one or more dry erase pens 13c. As shown in FIG. 4, showing the top plan view of the assembly base 30 in the first preferred embodiment, the pen retaining member may be an elongated pen-storing compartment 13e defined within the assembly base 30, into which the dry erase pen 13c may be inserted through an opening defined on a side surface of the assembly base 30 which is also shown in FIG. 7. Part of the compartment 13e and the dry erase pen 13c may be viewable through a compartment window 13d defined on the assembly base 30. But, in another embodiment (not shown), the pen retaining member may be a pocket-type pen holder attached on, for example, a side surface of the assembly frame 20.

The glossy dry erase surface 13 may further include a magnetic layer disposed underneath that attracts magnets to the surface 13. FIG. 2 shows that how memo notes or pieces of paper 13b are detachably retained against the dry erase surface 13 via such magnets 13a. The magnetic layer may be formed by coating upon any non-magnetic substrate metallic particulate or other polymeric compositions containing ferromagnetic particles. It can be obtained also by applying a magnetic paint formed from the mix of ferromagnetic particles with a surfactant and a paint to a non-magnetic substrate. Further, the magnetic layer could be a thin metallic layer such as steel or the like. The typical composing material of, and the process of coating, printing, or otherwise making, such magnetic layer are well known in the art. Moreover, as shown FIGS. 1, 2, and 4-6, the assembly base 30 may define a magnet-storing compartment or a recess 32 covered by a cover 33, as shown in FIGS. 4 and 5, to store therein one or more note-retaining magnets 13a.

In this first preferred embodiment, the size of the board 10 is, though not specifically limited, preferably big enough to retain a photo having dimensions of at least 3 and ⅛ inches by 4 and ⅜ inches, the size of commonly used photos. Having a dry erase surface 13 of a comparable area would be also desirable for the multi-purpose board 10 to be of any practical use as a dry erase board. The size and shape of the assembly frame 20 would be accordingly determined depending on those of the multi-purpose board 10.

Further in this first preferred embodiment, the multi-function assembly 1 may further comprise a digital signal generator 25, such as a digital alarm clock, a countdown alarm timer, or a thermometer, encased preferably in the assembly frame 20. For displaying the digital signal, the assembly frame 20 may further comprise a LCD and define a display window 25a, preferably on the front frame side 21 below the board cavity 11 as depicted in FIGS. 1 and 2. Moreover, the assembly frame 20 may further comprise, preferably on the rear frame side 22 below the board cavity 11 as shown in FIG. 3, a battery compartment 28a for supplying power to the digital signal generator 25, a speaker 28b for alarm sound, and control input buttons 28c for controlling or setting the digital signal generator 25. The electric circuits used for such common desktop electronics and method of displaying signals through LCD are well known in the art, and thus, not further described here.

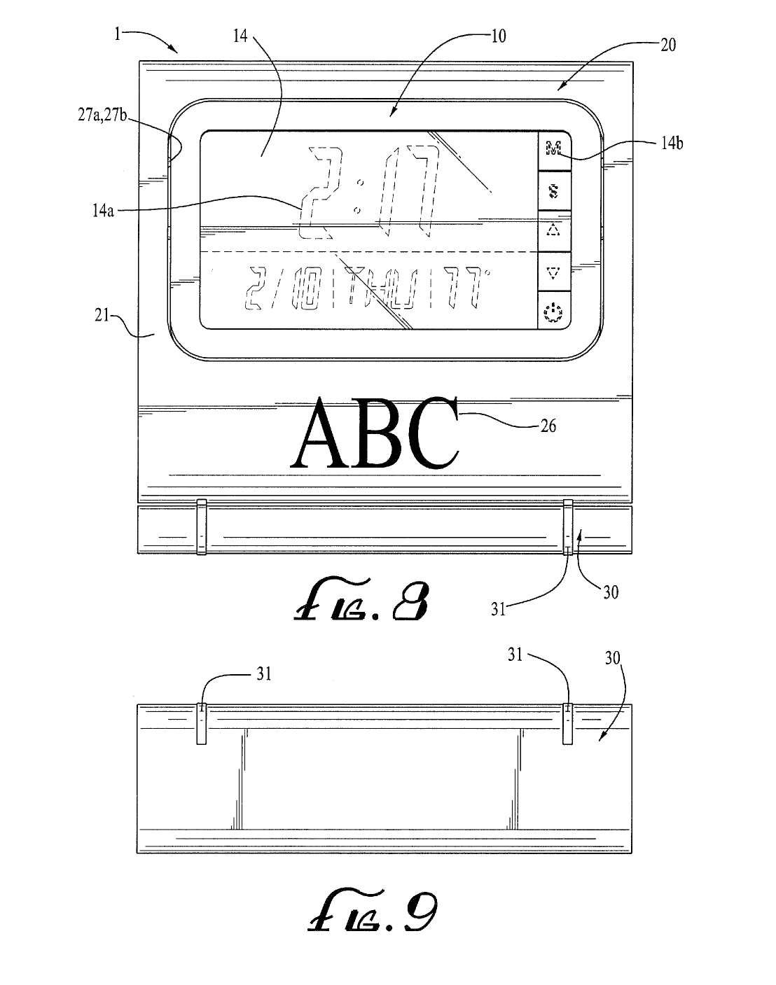

In the second preferred embodiment of the present invention, the multi-purpose board 10 has a LCD-mirror 14 formed on one side, and a photo frame 12 formed on the other side. FIG. 8 shows the LCD-mirror side 14 of the board 10 in the second preferred embodiment, aligned coplanar with the front frame side 21 of the multi-function desktop assembly 1. It is well known in the art that a LCD can be constructed such that it may operate as a common LCD when powered, and as a mirror when the power is off, either via an incident-light-reflecting polarizer placed behind the LCD, or via a dichroic mirror coatings attached on the substrate. Therefore, the technical details of implementing such a LCD-mirror is not described further herein.

In this embodiment, the multi-purpose board 10 may encase therein multiple digital signal generators such as a digital alarm clock, a countdown alarm timer, and a thermometer, whereby the digital signals 14a generated from them are selectively displayed, separately or together, on the LCD 14. Also, to select among different digital signals and to power on and off the LCD, the multi-purpose board 10 may have control buttons and a power button 14b, formed, preferably, on the LCD-mirror 14 as seen in FIG. 3. Further, a battery compartment containing batteries may be defined on, preferably, a side edge 15 of the board 10 to supply power for the digital signal generators and the LCD.

On the other side of the board 10, a photo frame is formed in the same way described in the first preferred embodiment. Therefore in this embodiment, the multi-purpose board 10 is used as a moderately sized high quality desktop mirror when power is off, which turns into a jumbo LCD screen displaying time, day-date, or a room temperature simply by pushing a power button, which then may be conveniently rotated to display a photo or a picture on the other side.

The third preferred embodiment of the multi-purpose board 10 (not shown) consists of another permutation of the functionalities that have been disclosed in the first and second embodiments. In this embodiment, the magnetic, dry erase surface 13 in the first preferred embodiment is formed on one side of the board 10 and the LCD-mirror 14 in the second preferred embodiment is formed on the other side. Accordingly, a dry erase pen 13c, a pen-storing compartment 13e, a compartment window 13d, and a magnet-storing compartment 32 with its cover 33 may be formed on the assembly base 30 as shown in FIG. 4.

In all three preferred embodiments, the multi-function assembly 1 may further comprise a battery compartment, formed either in the assembly base 30 or assembly frame 20 for supplying power to the encased electronics described above; and a speaker for emitting alarm sound, formed preferably in the front frame side 21 of the assembly frame 20.

The three preferred embodiments described above are not all of the embodiments contemplated for the multi-purpose board in the present invention. For example, in one embodiment, the magnetic, dry erase surface may be formed on both sides of the multi-purpose board for the purpose of procuring larger spaces for either dry erasing or retaining memo notes. Similarly, in another embodiment, photo frames may be formed on both sides of the board for the purpose of retaining different photos or pictures.

FIGS. 5 and 6 are a side view of the multi-function desktop assembly 1 in the preferred embodiment in which the assembly frame 20 is in a substantially upright position, being slightly tilted back from the strict upright position toward the rear frame side 21. This position of the assembly frame 20 would be usually most preferable for viewing the photos or pictures, reading messages written on the dry-erase surface or the memo notes retained on the magnetic surface, or viewing the mirror or digital signals on the LCD. FIG. 5 also shows the multi-purpose board 10 being rotated out of the plane of the assembly frame 20.

FIG. 7 shows the assembly frame 20 in a substantially flat position. As described previously, this substantially flat position of the assembly frame 20 may be obtained by other means than the hinged connection with the assembly base 30. Having the assembly frame 20 in such a position would be particularly desirable where the dry erase surface 13 is formed on a side of the multi-purpose board 10, as in the first and third preferred embodiments, for the obvious reason that, then, it would be much easier to write or draw on the dry erase surface 13. Having such a position, however, may be useful at other times as well. For example, the assembly frame 1 in such a flat position may be hung on the wall for viewing the photo or the LCD mirror on the board 10 when the other side of the board need not be frequently used. For such a purpose, the assembly frame may further define a hanging recess 16, preferably on the rear frame side 22 as shown in FIG. 3, in which a connector such as a nail may be lodged to thereby hang the assembly 1 on an external wall.

Lastly, the present invention also provides an effective method for advertising and promotion. Since the present invention would be accessed and used, supposedly, more frequently by a user owing to its integrated multiple functionality, it can be an effective vehicle for such purpose, whereby advertising or graphic materials can be permanently imprinted on any outer surface of the desktop assembly. FIGS. 1-3 show that advertising materials 26 imprinted on the front frame side 21 of the assembly frame 20, preferably below the multi-purpose board 10. But such advertising indicia may be placed on any other surface of the desktop assembly 1.

The present invention is capable of embodiments other than those described above, and its several details are capable of modifications in various respects apparent to those of ordinary skill in the art, all without departing from the essential spirit or attributes of the invention. Therefore, the embodiments described hereinbefore should be considered to be merely illustrative, not restrictive.

What is claimed is:

1. A multi-function desktop assembly comprising:
(a) a generally planar assembly frame having a front frame side and an opposing rear frame side, said frame defining a board cavity extending between the frame sides; and
(b) a multi-purpose board sized and configured to substantially fit within said board cavity, said board having a first board side and an opposing second board side, said board further having a substantially planar substrate,
wherein said board is connected to said assembly frame and selectively positionable relative to said assembly frame within said cavity between a first position where the first board side lies generally coplanar with the first frame side, and a second position where the second board side lies generally coplanar with the first frame side.

2. The multi-function desktop assembly as in claim 1, wherein said multi-purpose board is pivotally connected to said assembly frame such that said board is freely rotatable within said cavity.

3. The multi-function desktop assembly as in claim 2, wherein said multi-purpose board has two symmetric opposing board edges and said assembly frame has two symmetric opposing frame edges adjacent said cavity, and said board is pivotally connected at centers of the two board edges to the two frame edges, thereby defining a rotational axis connecting the centers, such that said board is rotatable about the rotational axis.

4. The multi-function desktop assembly as in claim 3, wherein said board cavity has a closed peripheral edge.

5. The multi-function desktop assembly as in claim 4, further comprising a supporting member being configured and connected to said assembly frame so as to support said assembly frame in a substantially upright position.

6. The multi-function desktop assembly as in claim 1, wherein said multi-purpose board further comprises:
(a) a dry-erase layer superimposed upon the first board side of said substrate, said dry-erase layer being configured so as to define a glossy dry-erase surface on the first board side for applying thereon non-permanent, dry erasable markings; and
(b) means for interchangeably retaining at least one graphics and displaying the at least one graphics on the second board side of said substrate.

7. The multi-function desktop assembly as in claim 6, wherein said multi-purpose board is pivotally connected to said assembly frame such that said board is freely rotatable within said cavity.

8. The multi-function desktop assembly as in claim 7, wherein said multi-purpose board has two symmetric opposing board edges and said assembly frame has two symmetric opposing frame edges adjacent said cavity, and said board is pivotally connected, substantially at centers of the two board edges, to the two frame edges, thereby defining a rotational axis connecting the centers, such that said board is rotatable about the rotational axis.

9. The multi-function desktop assembly as in claim 8, wherein said board cavity has a closed peripheral edge.

10. The multi-function desktop assembly as in claim 9, further comprising a supporting member being configured and connected to said assembly frame so as to support said assembly frame in a substantially upright position.

11. The multi-function desktop assembly as in claim 10, wherein said assembly frame is selectively positionable between the upright position and a flat position parallel to a horizontal surface.

12. The multi-function desktop assembly as in claim 11, wherein said supporting member comprises an assembly base hingedly connected to a bottom edge of said assembly frame for hinged rotation of said assembly frame between the upright and flat positions.

13. The multi-function desktop assembly as in claim 12, further comprising advertising material imprinted on at least one outer surface of said assembly.

14. The multi-function desktop assembly as in claim 6, wherein said means is for interchangeably retaining and selectively displaying at least one substantially planar graphic bearing member.

15. The multi-function desktop assembly as in claim 14, wherein the at least one substantially planar graphic bearing member has dimensions of at least 3 and ⅛ inches by 4 and ⅜ inches.

16. The multi-function desktop assembly as in claim 15, wherein said means further comprises a transparent cover removably disposed upon the least one substantially planar graphic bearing member.

17. The multi-function desktop assembly as in claim 6, wherein said means is for interchangeably retaining and selectively displaying a plurality of digital graphics.

18. The multi-function desktop assembly as in claim 17, wherein said means comprises:
(a) a slot defined on said board for removably receiving an external memory device containing the plurality of digital graphics;
(b) a screen formed on the second board side for displaying the plurality of digital graphics thereon;
(c) an electric circuitry encased in the board for reading and selectively displaying the plurality of digital graphics on said screen;
(d) a power unit encased in said board for supplying power to said electric circuit and said screen; and
(e) an input unit disposed on the board for turning on or off power and selecting among the plurality of digital graphics.

19. The multi-function desktop assembly as in claim 6, further comprising at least one pen retaining member formed on said assembly.

20. The multi-function desktop assembly as in claim 6, wherein said multi-purpose board further comprises a magnetic layer disposed between said substrate and said dry-erase layer, said magnetic layer being configured such that magnets can be removably adhered to the dry-erase surface.

21. The multi-function desktop assembly as in claim 20, further comprising a compartment disposed on said assembly base for storing magnets therein, and a compartment cover removably disposed thereon.

22. The multi-function desktop assembly as in claim 6, further comprising a digital signal generator encased within said assembly frame and said assembly frame further defines a display window on the front frame side, whereby a digital signal generated by said generator is displayed through said window.

23. The multi-function desktop assembly as in claim 22, wherein said digital signal generator comprises a digital alarm clock.

24. The multi-function desktop assembly as in claim 23, wherein said digital signal generator further comprises a digital thermometer.

25. The multi-function desktop assembly as in claim 1, wherein said multi-purpose board further comprises:
(a) a LCD disposed upon the first board side of said substrate, said LCD being configured to be a reflective mirror when unpowered and a common LCD when powered; and
(b) means for interchangeably retaining at least one graphics and displaying the at least one graphics on the second board side of said substrate.

26. The multi-function desktop assembly as in claim 25, wherein said multi-purpose board is pivotally connected to said assembly frame such that said board is freely rotatable within said cavity.

27. The multi-function desktop assembly as in claim 26, wherein said multi-purpose board has two symmetric opposing board edges and said assembly frame has two symmetric opposing frame edges adjacent said cavity, and said board is pivotally connected, substantially at centers of the two board edges, to the two frame edges, thereby defining a rotational axis connecting the centers, such that said board is rotatable about the rotational axis.

28. The multi-function desktop assembly as in claim 27, wherein said board cavity has a closed peripheral edge.

29. The multi-function desktop assembly as in claim 28, further comprising a supporting member being configured and connected to said assembly frame so as to support said assembly frame in a substantially upright position.

30. The multi-function desktop assembly as in claim 29, wherein said assembly frame is selectively positionable between the upright position and a flat position parallel to a horizontal surface.

31. The multi-function desktop assembly as in claim 30, wherein said supporting member comprises an assembly base hingedly connected to a bottom edge of said assembly frame for hinged rotation of said assembly frame between the upright and flat positions.

32. The multi-function desktop assembly as in claim 31, further comprising advertising material imprinted on at least one outer surface of said assembly.

33. The multi-function desktop assembly as in claim 25, wherein said multi-purpose board further comprises:
(a) a digital signal generator encased in said board, said generator generating at least one digital signal for display on said LCD;
(b) a power control unit encased in said board for supplying power to said LCD and said digital signal generator; and
(c) an input unit disposed on said LCD for turning on or off power and selecting among the at least one digital signal.

34. The multi-function desktop assembly as in claim 33, wherein said digital signal generator comprises a digital alarm clock.

35. The multi-function desktop assembly as in claim 34, wherein said digital signal generator further comprises a digital thermometer.

36. The multi-function desktop assembly as in claim 25, wherein said means is for interchangeably retaining and selectively displaying at least one substantially planar graphic bearing member.

37. The multi-function desktop assembly as in claim 36, wherein the at least one substantially planar graphic bearing member has dimensions of at least 3 and ⅛ inches by 4 and ⅜ inches.

38. The multi-function desktop assembly as in claim 37, wherein said means further comprises a transparent cover removably disposed upon the least one substantially planar graphic bearing member.

39. The multi-function desktop assembly as in claim 25, wherein said means is for interchangeably retaining and selectively displaying a plurality of digital graphics.

40. The multi-function desktop assembly as in claim 39, wherein said means comprises:
(a) a slot defined on said board for removably receiving an external memory device containing the plurality of digital graphics;
(b) a screen formed on the second board side for displaying the plurality of digital graphics thereon;
(c) an electric circuitry encased in the board configured to read and selectively display the plurality of digital graphics on said screen;
(d) a power unit encased in said board for supplying power to said electric circuit and said screen; and
(e) an input unit disposed on the board for turning on or off power and selecting among the plurality of digital graphics.

41. The multi-function desktop assembly as in claim 1 wherein said multi-purpose board further comprises:
(a) a LCD disposed upon the first board side of said substrate, said LCD being configured to be a reflective mirror when unpowered and a common LCD when powered; and
(b) a dry-erase layer superimposed upon the second board side of said substrate, said dry-erase layer being configured so as to define a glossy dry-erase surface on the erase-board side for applying thereon non-permanent, dry erasable markings.

42. The multi-function desktop assembly as in claim 41, wherein said multi-purpose board is pivotally connected to said assembly frame such that said board is freely rotatable within said cavity.

43. The multi-function desktop assembly as in claim 42, wherein said multi-purpose board has two symmetric opposing board edges and said assembly frame has two symmetric opposing frame edges adjacent said cavity, and said board is pivotally connected, substantially at centers of the two board edges, to the two frame edges, thereby defining a rotational axis connecting the centers, such that said board is rotatable about the rotational axis.

44. The multi-function desktop assembly as in claim 43, wherein said board cavity has a closed peripheral edge.

45. The multi-function desktop assembly as in claim 44, further comprising a supporting member being configured and connected to said assembly frame so as to support said assembly frame in a substantially upright position.

46. The multi-function desktop assembly as in claim 45, wherein said assembly frame is selectively positionable between the upright position and a flat position parallel to a horizontal surface.

47. The multi-function desktop assembly as in claim 46, wherein said supporting member comprises an assembly base hingedly connected to a bottom edge of said assembly frame for hinged rotation of said assembly frame between the upright and flat positions.

48. The multi-function desktop assembly as in claim 47, further comprising advertising material imprinted on at least one outer surface of said assembly.

49. The multi-function desktop assembly as in claim 41, wherein said multi-purpose board further comprises:
(1) a digital signal generator encased in said board, said generator generating at least one digital signal for display on said LCD;
(2) a power control unit encased in said board for supplying power to said LCD and said digital signal generator; and
(3) an input unit disposed on said LCD for turning on or off power and selecting among the at least one digital signal.

50. The multi-function desktop assembly as in claim 49, wherein said digital signal generator comprises a digital alarm clock.

51. The multi-function desktop assembly as in claim 50, wherein said digital signal generator further comprises a digital thermometer.

52. The multi-function desktop assembly as in claim 41, further comprising at least one pen retaining member formed on said assembly.

53. The multi-function desktop assembly as in claim 41, wherein said multi-purpose board further comprises a magnetic layer disposed between said substrate and said dry-erase layer, said magnetic layer being configured such that magnets can be removably adhered to the dry-erase surface.

54. The multi-function desktop assembly as in claim 53, further comprising a compartment disposed on said assembly base for storing magnets therein, and a compartment cover removably disposed thereon.

55. A multi-purpose board comprising:
(a) a generally planar substrate having a first board side and an opposed second board side;
(b) a dry-erase layer superimposed upon the first board side of said substrate, said layer being configured so as to define a glossy dry-erase surface for applying thereon non-permanent, dry erasable markings; and
(c) means for interchangeably retaining at least one graphics and displaying the at least one graphics on the second board side of said substrate.

56. The multi-function desktop assembly as in claim 55, wherein said means is for interchangeably retaining and selectively displaying at least one substantially planar graphic bearing member.

57. The multi-purpose board as in claim 56, wherein the at least one substantially planar graphic bearing member has dimensions of at least 3 and ⅛ inches by 4 and ⅜ inches.

58. The multi-purpose board as in claim 57, wherein said means further comprises a transparent cover removably disposed upon the least one substantially planar graphic bearing member.

59. The multi-purpose board as in claim 55, wherein said means is for interchangeably retaining and selectively displaying a plurality of digital graphics.

60. The multi-purpose board as in claim 59, wherein said means comprises:
(a) a slot defined on said board for removably receiving an external memory device containing the plurality of digital graphics;
(b) a screen formed on the second board side for displaying the plurality of digital graphics thereon;
(c) an electric circuitry encased in the board configured to read and selectively display the plurality of digital graphics on said screen;
(d) a power unit encased in said board for supplying power to said electric circuit and said screen; and
(e) an input unit disposed on the board for turning on or off power and selecting among the plurality of digital graphics.

61. The multi-purpose board as in claim 55, wherein said board further comprises a magnetic layer disposed between said substrate and said dry-erase layer, said magnetic layer being configured such that magnets can be removably adhered to the dry-erase surface.

62. A multi-purpose board comprising:
(a) a generally planar substrate having a first board side and an opposed second board side;
(b) a LCD disposed upon the first board side of said substrate, said LCD being configured to be a reflective mirror when unpowered and a common LCD when powered; and
(c) means for interchangeably retaining at least one graphics and displaying the at least one graphics on the second board side of said substrate.

63. The multi-purpose board as in claim 62, further comprising:
(a) a digital signal generator encased in said board, said generator generating at least one digital signal for display on said LCD;
(b) a power control unit encased in said board for supplying power to said LCD and said digital signal generator; and
(c) an input unit disposed on said LCD for turning on or off power and selecting among the at least one digital signal.

64. The multi-purpose board as in claim 63, wherein said digital signal generator comprises a digital alarm clock.

65. The multi-purpose board as in claim 64, wherein said digital signal generator further comprises a digital thermometer.

66. The multi-function desktop assembly as in claim 62, wherein said means is for interchangeably retaining and selectively displaying at least one substantially planar graphic bearing member.

67. The multi-purpose board as in claim 66, wherein the at least one substantially planar graphic bearing member has dimensions of at least 3 and ⅛ inches by 4 and ⅜ inches.

68. The multi-purpose board as in claim 67, wherein said means further comprises a transparent cover removably disposed upon the least one substantially planar graphic bearing member.

69. The multi-purpose board as in claim 62, wherein said means is for interchangeably retaining and selectively displaying a plurality of digital graphics.

70. The multi-purpose board as in claim 69, wherein said means comprises:
(a) a slot defined on said board for removably receiving an external memory device containing the plurality of digital graphics;
(b) a screen formed on the second board side for displaying the plurality of digital graphics thereon;
(c) an electric circuitry encased in the board configured to read and selectively display the plurality of digital graphics on said screen;
(d) a power unit encased in said board for supplying power to said electric circuit and said screen; and
(e) an input unit disposed on the board for turning on or off power and selecting among the plurality of digital graphics.

71. A multi-purpose board comprising:
(a) a generally planar substrate having a first board side and an opposed second board side;
(b) a LCD disposed upon the first board side of said substrate, said LCD being configured to be a reflective mirror when unpowered and a common LCD when powered; and
(c) a dry-erase layer superimposed upon the second board side of said substrate, said layer being configured so as to define a glossy dry-erase surface for applying thereon non-permanent, dry erasable markings.

72. The multi-purpose board as in claim 71, further comprising:
(a) a digital signal generator encased in said board, said generator generating at least one digital signal for display on said LCD;
(b) a power control unit encased in said board for supplying power to said LCD and said digital signal generator; and
(c) an input unit disposed on said LCD for turning on or off power and selecting among the at least one digital signal.

73. The multi-purpose board as in claim 72, wherein said digital signal generator comprises a digital alarm clock.

74. The multi-purpose board as in claim 73, wherein said digital signal generator further comprises a digital thermometer.

75. The multi-purpose board as in claim 71, wherein said board further comprises a magnetic layer disposed between said substrate and said dry-erase layer, said magnetic layer being configured such that magnets can be removably adhered to the dry-erase surface.

76. A method of advertising and promotion comprising the steps of:
(a) providing a multi-function desktop assembly comprising:
(1) a generally planar assembly frame having a front frame side and an opposing rear frame side, said frame defining a board cavity extending between the frame sides; and
(2) a multi-purpose board sized and configured to substantially fit within said board cavity, said board having a first board side and an opposing second board side, said board further having a substantially planar substrate,
wherein said board is connected to said assembly frame and selectively positionable relative to said assembly frame within said cavity between a first position where the first board side lies generally coplanar with the first frame side, and a second position where the second board side lies generally coplanar with the first frame side; and
(b) imprinting advertising material on at least one outer surface of said multi-function desktop assembly.

77. The method of advertising and promotion as in claim 76, wherein the step of providing The multi-purpose board further comprises the steps of:
(a) superimposing a dry-erase layer upon the first board side of said substrate, said dry-erase layer being configured so as to define a glossy dry-erase surface on the first board side for applying thereon non-permanent, dry erasable markings; and
(b) forming means on the board for interchangeably retaining at least one graphics and displaying the at least one graphics upon the second board side of said substrate.

78. The method of advertising and promotion as in claim 76, wherein the step of providing The multi-purpose board further comprises the steps of:
(a) disposing a LCD upon the first board side of said substrate, said LCD being configured to be a reflective mirror when unpowered and a common LCD when powered; and
(b) forming means on the board for interchangeably retaining at least one graphics and displaying the at least one graphics upon the second board side of said substrate.

79. The method of advertising and promotion as in claim 76, wherein the step of providing The multi-purpose board further comprises the steps of:
(a) disposing a LCD upon the first board side of said substrate, said LCD being configured to be a reflective mirror when unpowered and a common LCD when powered; and
(b) superimposing a dry-erase layer upon the second board side of said substrate, said dry-erase layer being configured so as to define a glossy dry-erase surface on the second board side for applying thereon non-permanent, dry erasable markings.
